(19) United States
(12) Patent Application Publication
(10) Pub. No.: US 2019/0281867 A1
(43) Pub. Date: Sep. 19, 2019

(54) COLD CHAIN SPOILAGE RECOGNITION AND MANAGEMENT SYSTEM

(71) Applicant: CARRIER CORPORATION, Jupiter Plam Beach Gardens, FL (US)

(72) Inventors: Marc Beasley, Beverly, MA (US); Ciara Poolman, Syracuse, NY (US); Robert A. Chopko, Baldwinsville, NY (US); John Cronin, Bonita Springs, FL (US); Michael Glynn D'Andrea, Burlington, VT (US); Jonathan T. Goguen, Brookline, NH (US)

(21) Appl. No.: 16/318,796

(22) PCT Filed: Jul. 20, 2017
(86) PCT No.: PCT/US2017/043052

§ 371 Date: Jan. 18, 2019

Related U.S. Application Data
(60) Provisional application No. 62/365,697, filed on Jul. 22, 2016.

(51) Int. Cl. A23L 3/3445; A23B 4/16; A23B 5/10; A23B 7/152; A23B 9/22; A23L 3/36; A23B 9/10; A23B 7/04; A23B 5/04; A23B 4/06

(52) U.S. Cl. CPC A23L 3/3445; A23B 4/16; A23B 5/10; A23B 7/152; A23B 9/22; A23V 2002/00; A23B 9/10; A23B 7/0425; A23B 5/04; A23B 4/066; A23L 3/363

(57) ABSTRACT

A system for managing spoilage of perishable goods including: a storage device to store perishable good requirements, spoilage characteristics, and perishable good parameters associated with the perishable goods; and a spoilage management system coupled to the storage device. The spoilage management system including: a quality assessment module to determine quality levels in response to at least one of the perishable good parameters and the perishable good requirements; a spoilage determination module to determine spoilage risk levels in response to at least one of the perishable good parameters, the spoilage characteristics, and the quality levels; and a meshing module to determine output parameters in response to at least one of the quality levels and the spoilage risk levels.

### BACKGROUND OF THE DISCLOSURE

The embodiments disclosed herein generally relate to cold chain distribution systems, and more specifically to an apparatus and a method for recognizing and managing spoilage of perishable goods.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

Consumers are becoming increasingly concerned with the quality of the perishable goods they are purchasing and spoilage leads to degradation of that quality. It is often difficult to predict the quality of perishable goods as the perishable goods may change hands several times along the route, thus making it difficult to manage spoilage. Improved systems, particularly improved systems for spoilage recognition and management would provide benefits to the industry.

### BRIEF DESCRIPTION OF THE DISCLOSURE

According to one embodiment, a system for managing spoilage of perishable goods is provided. The system includes: a storage device to store perishable good requirements, spoilage characteristics, and perishable good parameters associated with the perishable goods; and a spoilage management system coupled to the storage device. The spoilage management system including: a quality assessment module to determine quality levels in response to at least one of the perishable good parameters and the perishable good requirements; a spoilage determination module to determine spoilage risk levels in response to at least one of the perishable good parameters, the spoilage characteristics, and the quality levels; and a meshing module to determine output parameters in response to at least one of the quality levels and the spoilage risk levels.

In addition to one or more of the features described above, or as an alternative, further embodiments of the system may include a spoilage detection machine to collect perishable good parameters and transmit the perishable good parameters to the storage device.

In addition to one or more of the features described above, or as an alternative, further embodiments of the system may include that the spoilage determination module determines the spoilage risk using image recognition.

In addition to one or more of the features described above, or as an alternative, further embodiments of the system may include that the meshing module is configured to transmit output parameters to a user device.

In addition to one or more of the features described above, or as an alternative, further embodiments of the system may include that the storage device is configured to receive perishable good parameters from a user device.

In addition to one or more of the features described above, or as an alternative, further embodiments of the system may include that the output parameters include at least one of the quality level, the spoilage risk level, a check recommendation, and a remove recommendation.

In addition to one or more of the features described above, or as an alternative, further embodiments of the system may include a user device that activates an alarm when the spoilage risk level is greater than or equal to a selected spoilage risk level.

In addition to one or more of the features described above, or as an alternative, further embodiments of the system may include at least one sensor configured to monitor the perishable good parameters of the perishable goods and transmit the perishable good parameters to the storage device.

According to another embodiment, a method of managing spoilage of perishable goods. The method includes: storing, using a storage device, perishable good requirements, spoilage characteristics, and perishable good parameters associated with the perishable goods; and analyzing, using a spoilage management system, the perishable good requirements, the spoilage characteristics, and perishable good parameters. The spoilage management system coupled to the storage device. The spoilage management system including: a quality assessment module to determine quality levels in response to at least one of the perishable good parameters and the perishable good requirements; a spoilage determination module to determine spoilage risk levels in response to at least one of the perishable good parameters, the spoilage characteristics, and the quality levels; and a meshing module to determine output parameters in response to at least one of the quality levels and the spoilage risk levels.

In addition to one or more of the features described above, or as an alternative, further embodiments of the method may include collecting, using a spoilage detection machine, perishable good parameters; and transmitting the perishable good parameters to the storage device.

In addition to one or more of the features described above, or as an alternative, further embodiments of the method may include that the spoilage determination module determines the spoilage risk using image recognition.

In addition to one or more of the features described above, or as an alternative, further embodiments of the method may include transmitting, using the meshing module, output parameters to a user device.

In addition to one or more of the features described above, or as an alternative, further embodiments of the method may include receiving, using the storage device, perishable good parameters from a user device.

In addition to one or more of the features described above, or as an alternative, further embodiments of the method may include that the output parameters include at least one of the quality level, the spoilage risk level, a check recommendation, and a remove recommendation.

In addition to one or more of the features described above, or as an alternative, further embodiments of the method may include activating, using a user device, an alarm when the spoilage risk level is greater than or equal to a selected spoilage risk level.

In addition to one or more of the features described above, or as an alternative, further embodiments of the method may include monitoring, using at least one sensor, the perishable good parameters of the perishable goods; and transmitting the perishable good parameters to the storage device.

According to another embodiment, computer program product tangibly embodied on a computer readable medium is provided. The computer program product including instructions that, when executed by a processor, cause the processor to perform operations comprising: storing, using a storage device, perishable good requirements, spoilage characteristics, and perishable good parameters associated with the perishable goods; and analyzing, using a spoilage management system, the perishable good requirements, the spoilage characteristics, and perishable good parameters. The spoilage management system coupled to the storage device. The spoilage management system including: a quality assessment module to determine quality levels in response to at least one of the perishable good parameters and the perishable good requirements; a spoilage determination module to determine spoilage risk levels in response to at least one of the perishable good parameters, the spoilage characteristics, and the quality levels; and a meshing module to determine output parameters in response to at least one of the quality levels and the spoilage risk levels.

In addition to one or more of the features described above, or as an alternative, further embodiments of the computer program may include that the operations further include: collecting, using a spoilage detection machine, perishable good parameters; and transmitting the perishable good parameters to the storage device.

In addition to one or more of the features described above, or as an alternative, further embodiments of the computer program may include that the spoilage determination module determines the spoilage risk using image recognition.

In addition to one or more of the features described above, or as an alternative, further embodiments of the computer program may include that the operations further include: transmitting, using the meshing module, output parameters to a user device.

In addition to one or more of the features described above, or as an alternative, further embodiments of the computer program may include that the operations further include: receiving, using the storage device, perishable good parameters from a user device.

In addition to one or more of the features described above, or as an alternative, further embodiments of the computer program may include that the output parameters include at least one of the quality levels, the spoilage risk levels, a check recommendation, and a remove recommendation.

In addition to one or more of the features described above, or as an alternative, further embodiments of the computer program may include that the operations further include: activating, using a user device, an alarm when the spoilage risk level is greater than or equal to a selected spoilage risk level.

In addition to one or more of the features described above, or as an alternative, further embodiments of the computer program may include that the operations further include: monitoring, using at least one sensor, the perishable good parameters of the perishable goods; and transmitting the perishable good parameters to the storage device.

Technical effects of embodiments of the present disclosure include tracking various parameters of perishable goods and using the parameters to determine whether a perishable good may spoil.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for managing spoilage of perishable goods, according to an embodiment of the present disclosure;

FIG. 2 illustrates a schematic view of a cold chain distribution system that may incorporate embodiments of the present disclosure;

FIG. 3 illustrates spoilage images of a perishable good, according to an embodiment of the present disclosure; and

FIG. 4 is a flow diagram illustrating a method of managing spoilage of perishable goods, according to an embodiment of the present disclosure.

### DETAILED DESCRIPTION OF THE DISCLOSURE

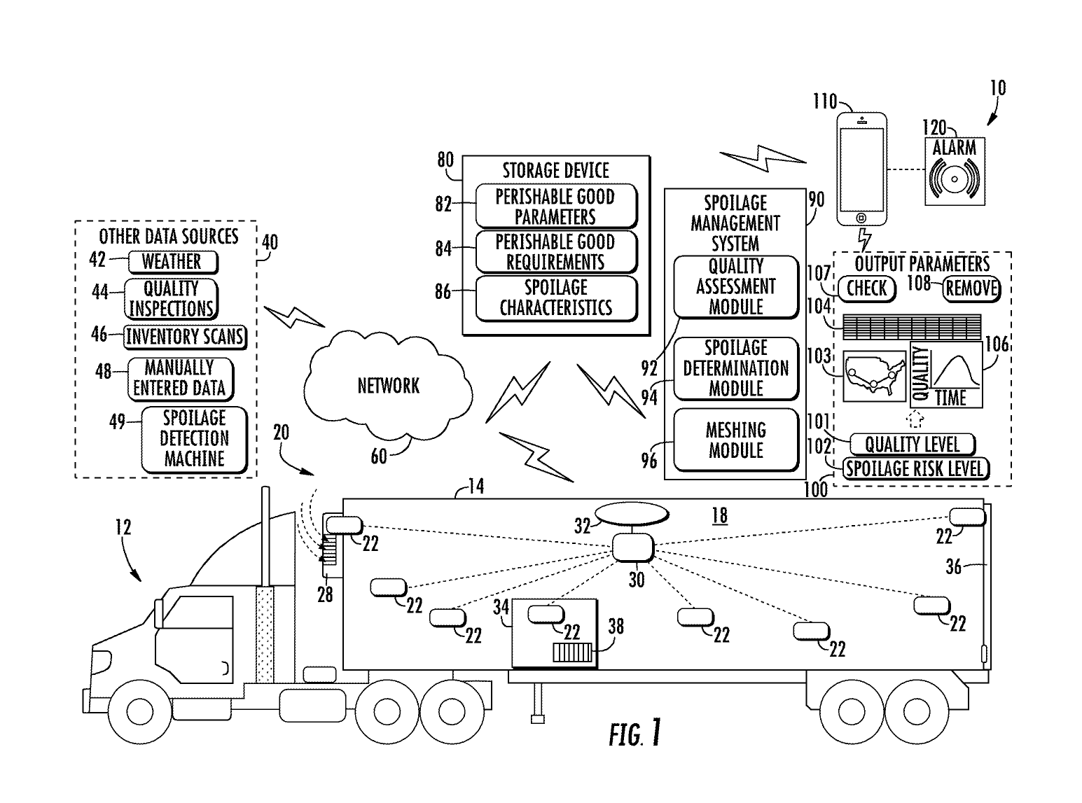

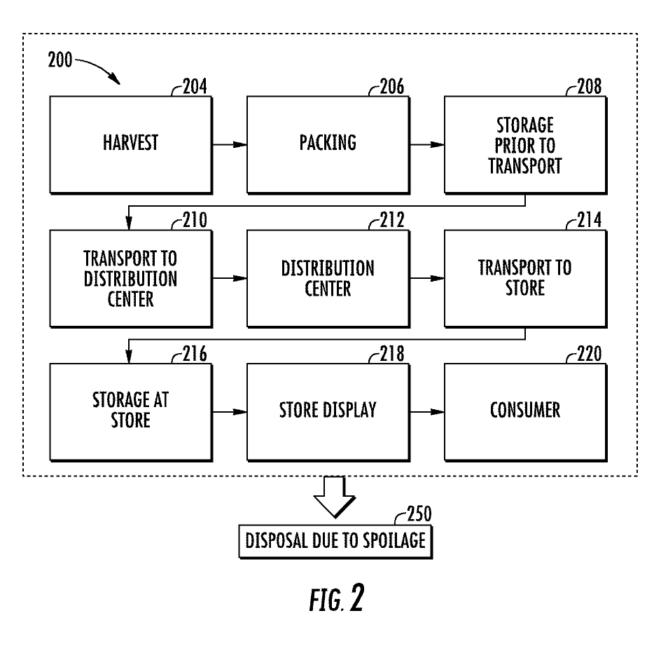

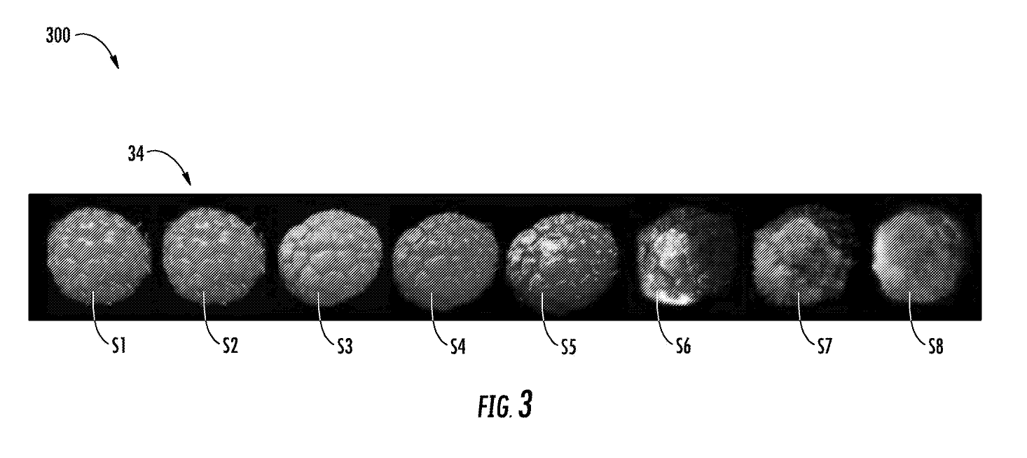

Referring now to the drawings, FIG. 1 illustrates a schematic view of a system 10 for managing spoilage of perishable goods 34, according to an embodiment of the present disclosure. FIG. 2 illustrates a schematic view of a cold chain distribution system 200 that may incorporate embodiments of the present disclosure. FIG. 3 illustrates spoilage stages S1, S2, S3, S4, S5, S6, S7, S8 of a perishable good 34, according to an embodiment of the present disclosure. Typically, transport refrigeration systems 20 are used to transport and distribute perishable goods and environmentally sensitive goods (herein referred to as perishable goods 34). In the illustrated embodiment, a transport refrigeration system 20 includes the environmentally controlled container 14, a transport refrigeration unit 28 and perishable goods 34. The container 14 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the transport refrigeration unit 28 is associated with a container 14 to provide desired environmental parameters, such as, for example, temperature, pressure, humidity, carbon dioxide, ethylene, ozone, light exposure, vibration exposure, and other conditions to the interior compartment 18. In an embodiment, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22, which may be hardwired or wireless. The sensors 22 may be utilized to monitor perishable good parameters 82 of the perishable goods 34. The perishable good parameters 82 monitored by the sensors 22 may include but are not limited to temperature, pressure, humidity, carbon dioxide, ethylene, ozone, light exposure, vibrations, and other conditions in the interior compartment 18. Accordingly, suitable sensors 22 are utilized to monitor the desired perishable good parameters 82. Advantageously, sensors 22 may be selected for certain applications depending on the type of perishable goods 34 to be monitored and the corresponding environmental sensitivities. For instance, perishable goods 34 that are hyper sensitive to carbon dioxide may require additional sensors 22 specifically for carbon dioxide. In an embodiment, temperatures are monitored. As seen in FIG. 1, the sensors 22 may be placed directly on the perishable goods 34.

Additionally, the sensors 22 may be placed in a variety of locations including but not limited to on the transport refrigeration unit 28, on a door 36 of the container 14, and throughout the interior compartment 18. The sensors 22 may be placed directly within the transport refrigeration unit 28 to monitor the performance of the transport refrigeration unit 28. As seen, the sensors 22 may also be placed on the door 36 of the container 14 to monitor the position of the door 36. Whether the door 36 is open or closed affects both the temperature of the container 14 and the perishable goods 34. For instance, in hot weather, an open door 36 will allow cooled air to escape from the container 14, causing the temperature of the interior compartment 18 to rise, thus affecting the temperature of the perishable goods 34 and potentially leading to spoilage. Additionally, a global positioning system (GPS) location may also be detected by the sensors 22. The GPS location may help in providing time-based location information for the perishable goods 34 that will help in tracking the travel route and other perishable good parameters 82 along that route. For instance, the GPS location may also help in providing information from other data sources 40 regarding weather 42 experienced by the container 14 along the travel route. The local weather 42 affects the temperature of the container 14 and thus may affect the temperature of the perishable goods 34.

As illustrated in FIG. 1, the transport refrigeration system 20 may further include, a controller 30 configured to log a plurality of readings from the sensors 22, known as the perishable good parameters 82, at a selected sampling rate. The controller 30 may be enclosed within the transport refrigeration unit 28 or separate from the transport refrigeration unit 28 as illustrated. The perishable good parameters 82 may further be augmented with time, location stamps or other relevant information. The controller 30 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 20 may include a communication module 32 in operative communication with the controller 30 and in wireless operative communication with a network 60. The communication module 32 is configured to transmit the perishable good parameters 82 to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface. The short range interface includes at least one of: a wired interface, an optical interface, and a short range wireless interface.

Perishable good parameters 82 may also be provided by other data sources 40, as illustrated in FIG. 1. These other data sources 40 may be collected at any stage throughout the cold chain distribution system 200, which as illustrated in FIG. 2 may include harvest 204, packing 206, storage prior to transport 208, transport to distribution center 210, distribution center 212, transport to store 214, storage at store 216, store display 218 and consumer 220. These stages are provided for illustrative purposes and a distribution chain may include fewer stages or additional stages, such as, for example, a cleaning stage, a processing stage, and additional transportation stages. An additional stage of the cold chain distribution system 200 may include disposal due to spoilage 250. Disposal due to spoilage 250 may occur at any point throughout the cold chain distribution system 200 and perishable good parameters 82 may be collected at the disposal due to spoilage 250 stage to help better determine how the perishable goods 34 are spoiling and why the perishable goods 34 are spoiling. Perishable good parameters 82 collected at the disposal due to spoilage 250 stage may help create spoilage characteristics 86. Spoilage characteristics 86 are perishable good parameters 82 that may be indicative of spoilage. Spoilage characteristics 86 may include, a change in color, an odor, a fluid discharge, a change in moisture content, a change in texture, increase in yeast, increase in mold, increase in bacteria, increase in fungus, or any other known spoilage indicator known to one of skill in the art.

The other data sources 40 may include, but are not limited to, weather 42, quality inspections 44, inventory scans 46, and manually entered data 48. The weather 42, as discussed above, has an effect on the operation of the transport refrigeration unit 28 by influencing the temperature of the container 14 during transport (e.g., 210 and 214) but the weather 42 also has other influences on the transport refrigeration unit 28. For instance, the weather 42 prior to and at harvest 204 may have an impact on the quality of the perishable goods 34. Moreover, quality inspections 44, similar to the weather 42, may reveal data of the perishable goods 34 that affects quality and potential for spoilage during transport. For instance, a particular batch of strawberries was subjected to rainfall just prior to harvest 204, making them prone to spoilage while in the container 14. Quality inspections 44 may be done by a machine or a human being. Quality inspections 44 may also be performed by a spoilage detection machine 49 may be accomplished using a variety of techniques including but not limited to optical, odor, soundwave, infrared, or physical probe. The spoilage detection machine 49 may be located within the container 14, within boxes containing perishable goods 34, attached to the boxes containing perishable goods 34 and/or within the transportation unit 28. The spoilage detection machine 49 may be hard wired or wirelessly connected to the network 60. The spoilage detection machine 49 may be utilized to inspect the perishable goods 34 at any stage of the cold chain distribution system 200. For example, the spoilage detection machine 49 may be used at harvest 201 or at the store display 218 to ensure the perishable goods 34 are not spoiling. The spoilage detection machine 49 may operate automatically and/or manually. For instance, an inspector may operate the spoilage detection machine 49 manually or the spoilage detection machine 49 may be located within the container 14 to automatically monitor the perishable goods 34 for spoilage while in the container 14. In an embodiment, the spoilage detection machine 49 may be a camera and image recognition may be used to detect perishable good parameters 82 that might be indicative of spoilage. FIG. 3 shows a perishable good 34, such as a raspberry, at various spoilage stages S1, S2, S3, S4, S5, S6, S7, S8. The perishable good appears at a high quality in stage S1 and slowly degrades in quality to stage S8. These images of spoilage stages S1, S2, S3, S4, S5, S6, S7, S8 may be stored in the storage device 80 as spoilage characteristics. Thus, image recognition may be used to compare images of the perishable goods 34 from the spoilage detection machine 49 to images of spoilage stages to S1, S2, S3, S4, S5, S6, S7, S8 to determine a spoilage risk level 102. The perishable good parameters 82 that might be indicative of spoilage are known as spoilage characteristics 86, as discussed above. In another embodiment, the spoilage detection machine 49 may be a thermographic camera. In yet another embodiment, the spoilage detection machine 49 may be a spectral imaging camera, such as for example a hyperspectral imaging camera.

Further, inventory scans 46 may also reveal perishable good parameters 82 about the perishable goods 34 and may help in tracking the perishable goods 34. For instance, the inventory scan 46 may reveal the time, day, truck the perishable goods 34 arrived on, which may help identify the origin of the perishable goods 34 if previously unknown. Knowing the origin of the perishable goods 34 may help in tracking potential spoilage issues that may arise at a particular farm or production plant. For instance, one farm from a specific geographical location may experience a disease in an orange crop causing the oranges to spoil at a different rate than oranges from another geographical location without the disease. Thus, perishable goods from certain geographical locations may need to be monitored for spoilage differently. While the system 10 includes sensors 22 to aid in automation, often times the need for manual data entry is unavoidable. The manually entered data 48 may be input via a variety of user devices 110 including but not limited to a cellular phone, tablet, laptop, smartwatch, a desktop computer or any other similar data input device known to one of skill in the art.

Perishable good parameters 82 collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Perishable good parameters 82 may further include attributes of the perishable goods 34 such as, for example, temperature, weight, size, sugar content, maturity, grade, ripeness, labeling, packaging and the type of perishable good. For instance, strawberries may be packaged in 1 pound clamshells, be a certain weight or grade, be organic, and have certain packaging or labels on the clamshells. Packaging may offer some addition protection against spoilage while the perishable good 34 is being transported.

Perishable good parameters 82 may include information regarding the geographical origin and the type of perishable good. The origin of the perishable good 34 may help identify specific spoilage characteristics 86 associated with the geographic region and/or the producer of the perishable good 34. The origin and type of perishable good 34 within the container 14 may be identified by a manifest or contents list for the container 14 as manually entered data 48. The origin and type of perishable good 34 within the container 14 may also be identified by inventory scans 46, or scans of ID tags 38. The ID tag 38 may be a Universal Product Code (UPC) bar code, Quick Response (QR) code, Radio-frequency identification (RFID) or another identification methodology known to one of skill in the art. Perishable good parameters 82 may also include information regarding the operation of the environmental control unit 28, as discussed above. The perishable good parameters 82 may further be augmented with time, location stamps or other relevant information.

In the illustrated embodiment, the system 10 further includes a storage device 80 to store the perishable good parameters 82 associated with the perishable goods 34, perishable good requirements 84, and spoilage characteristics 86. At least one of the perishable good parameters 82 may be received from a transport refrigeration system 20. The storage device 80 is connected to the communication module 32 through the network 60. As shown, the storage device 80 also stores consumer parameters 89. The storage device 80 may be but is not limited to a random access memory (RAM), read only memory (ROM), or other electronic, optical, magnetic or any other computer readable medium.

In the illustrated embodiment, the system 10 further includes a spoilage management system 90. The spoilage management system 90 is connected to the communication module 32 through the network 60. The spoilage management system 90 is also coupled to the storage device 80. As shown, the spoilage management system 90 includes a quality assessment module 92, a spoilage determination module 94, and a meshing module 96. The spoilage management system 90 may also include a processor (not shown) and an associated memory (not shown). The associated memory may be the storage device 80. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium. The quality assessment module 92, the spoilage determination module 94, and the meshing module 96 may be implemented in software as applications executed by the processor of spoilage management system 90.

The quality assessment module 92 determines quality levels 101 in response to at least one of the perishable good parameters 82 and the perishable good requirements 84. The spoilage determination module 94 determines spoilage risk levels 102 in response to at least one of the perishable good parameters 82, quality levels 101, and spoilage characteristics 86. The perishable good requirements 84 may be requirements for handling and/or packaging the perishable good 34 such as, for example, government regulations or industry standards. In an embodiment, the spoilage determination module 94 may use image recognition to determine spoilage risk levels 102. The quality levels 101 associated with the perishable good 34 may decrease if some of the perishable good parameters 82 do not satisfy the perishable good requirements 84. In one example, the quality levels 101 may decrease due to the perishable goods 34 being kept at elevated temperatures during transportation, which is recorded as a perishable good parameter 84.

The meshing module 96 determines output parameters 100 in response to at least one of the quality levels 101 and the spoilage risk levels 102. In an embodiment, the output parameters 100 may include at least one of the quality levels 101, the spoilage risk levels 102, a check recommendation 107, and a remove recommendation 108. The output parameters 100 may be accessible via the user device 110 and/or sent directly to the user device 110. The meshing module 96 may be configured to transmit the output parameters 100 to the user device 110. The output parameters 100 may be configured as at least one of a map 103 displaying time-based locations of the product 34 along with the output parameters 100 at the time-based locations, a data table 104 of output parameters 100, a output parameters 100 versus time graph 106, a text recommendations 107, 108, or any other method of displaying parameters known to one of skill in the art. In one example, the output parameters 100 may be configured as a quality level 101 versus time graph. In another example the output parameters 100 may be configured as a map displaying the quality levels 101 along the transportation route of the perishable goods 34.

The user device 110 may activate an alarm 120 when the quality level 101 is greater than or equal to a selected quality level. The user device 110 may also activate an alarm 120 when the spoilage risk level 102 is greater than or equal to a selected spoilage risk level. The alarm 120 may be audible and/or visual. The alarm 120 may include a check recommendation 107 and/or a remove recommendation 108. The check recommendation 107 may indicate that that spoilage risk level is approaching a selected spoilage risk level and the perishable good 34 should be inspected. The remove recommendation 108 may indicate that that spoilage risk level is equal to or greater than a selected spoilage risk level and the perishable good 34 should be removed and discarded. An individual may transmit perishable good parameters 86 to the storage device 80 using the user device 110. For example, once the perishable good 34 has been checked after the check recommendation 107, an individual may indicate that the check recommendation 107 has been performed on the user device 110 and provide perishable good parameters 82 describing the status of the perishable good 34. These perishable good parameters 82 may then be transmitted the storage device 80. The storage device 80 is configured to receive the perishable good parameters 82 from the user device 110.

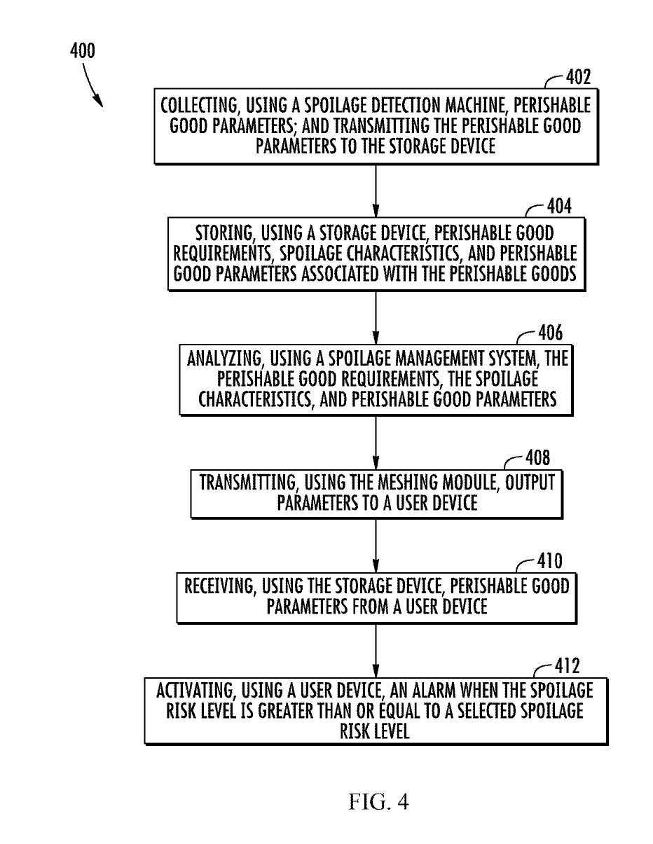

Referring now also to FIG. 4, which shows a flow diagram illustrating a method 400 of managing spoilage of perishable goods 34, according to an embodiment of the present disclosure. At block 402, the spoilage detection machine 49 collects perishable good parameters 82 and transmits the perishable good parameters 82 to the storage device 80. The method 300 may also include monitoring, using at least one sensor 22, the perishable good parameters 82 of the perishable goods 34; and transmitting the perishable good parameters 82 to the storage device 80. At block 404, the storage device 80 stores perishable good requirements 84, spoilage characteristics 86, and perishable good parameters 82 associated with the perishable goods 34.

At block 406, the spoilage management system 90 analyzes the perishable good requirements 84, the spoilage characteristics 86, and the perishable good parameters 82. The spoilage management system 90 is coupled to the storage device 80. As discussed above, the spoilage management system 90 includes: a quality assessment module 92 to determine quality levels 101 in response to at least one of the perishable good parameters 82 and the perishable good requirements 84; a spoilage determination module 94 to determine spoilage risk levels 102 in response to at least one of the perishable good parameters 82, the spoilage characteristics 86, and the quality levels 101; and a meshing module 96 to determine output parameters 100 in response to at least one of the quality levels 101 and the spoilage risk levels 102.

Further, at block 408, the meshing module 96 may transmit output parameters 100 to the user device 110. At block 410, the storage device 80 may receive perishable good parameters 82 from the user device 110. At block 412, the user device 110 may activate the alarm 120 when the spoilage risk level 102 is greater than or equal to the selected spoilage risk level.

While the above description has described the flow process of FIG. 4 in a particular order, it should be appreciated that unless otherwise specifically required in the attached claims that the ordering of the steps may be varied.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for managing spoilage of perishable goods, the system comprising:
a storage device to store perishable good requirements, spoilage characteristics, and perishable good parameters associated with the perishable goods; and
a spoilage management system coupled to the storage device, the spoilage management system including:
a quality assessment module to determine quality levels in response to at least one of the perishable good parameters and the perishable good requirements;
a spoilage determination module to determine spoilage risk levels in response to at least one of the perishable good parameters, the spoilage characteristics, and the quality levels; and
a meshing module to determine output parameters in response to at least one of the quality levels and the spoilage risk levels.

2. The system of claim 1, further comprising:
a spoilage detection machine to collect perishable good parameters and transmit the perishable good parameters to the storage device.

3. The system of claim 1, wherein:
the spoilage determination module determines the spoilage risk using image recognition.

4. The system of claim 1, wherein:
the meshing module is configured to transmit output parameters to a user device.

5. The system of claim 1, wherein:
the storage device is configured to receive perishable good parameters from a user device.

6. The system of claim 1, wherein:
the output parameters include at least one of the quality level, the spoilage risk level, a check recommendation, and a remove recommendation.

7. The system of claim 1, further comprising:
a user device that activates an alarm when the spoilage risk level is greater than or equal to a selected spoilage risk level.

8. The system of claim 1, further comprising:
at least one sensor configured to monitor the perishable good parameters of the perishable goods and transmit the perishable good parameters to the storage device.

9. A method of managing spoilage of perishable goods, the method comprising:
storing, using a storage device, perishable good requirements, spoilage characteristics, and perishable good parameters associated with the perishable goods; and
analyzing, using a spoilage management system, the perishable good requirements, the spoilage characteristics, and perishable good parameters, the spoilage management system coupled to the storage device, the spoilage management system including:
a quality assessment module to determine quality levels in response to at least one of the perishable good parameters and the perishable good requirements;
a spoilage determination module to determine spoilage risk levels in response to at least one of the perishable good parameters, the spoilage characteristics, and the quality levels; and
a meshing module to determine output parameters in response to at least one of the quality levels and the spoilage risk levels.

10. The method of claim 9, further comprising:
collecting, using a spoilage detection machine, perishable good parameters; and
transmitting the perishable good parameters to the storage device.

11. The method of claim 9, wherein:
the spoilage determination module determines the spoilage risk using image recognition.

12. The method of claim 9, further comprising:
transmitting, using the meshing module, output parameters to a user device.

13. The method of claim 9, further comprising:
receiving, using the storage device, perishable good parameters from a user device.

14. The method of claim 9, wherein:
the output parameters include at least one of the quality level, the spoilage risk level, a check recommendation, and a remove recommendation.

15. The method of claim 9, further comprising:
activating, using a user device, an alarm when the spoilage risk level is greater than or equal to a selected spoilage risk level.

16. The method of claim 9, further comprising:
monitoring, using at least one sensor, the perishable good parameters of the perishable goods; and
transmitting the perishable good parameters to the storage device.

17. A computer program product tangibly embodied on a computer readable medium, the computer program product including instructions that, when executed by a processor, cause the processor to perform operations comprising:
storing, using a storage device, perishable good requirements, spoilage characteristics, and perishable good parameters associated with the perishable goods; and
analyzing, using a spoilage management system, the perishable good requirements, the spoilage characteristics, and perishable good parameters, the spoilage management system coupled to the storage device, the spoilage management system including:
a quality assessment module to determine quality levels in response to at least one of the perishable good parameters and the perishable good requirements;
a spoilage determination module to determine spoilage risk levels in response to at least one of the perishable good parameters, the spoilage characteristics, and the quality levels; and
a meshing module to determine output parameters in response to at least one of the quality levels and the spoilage risk levels.

18. The computer program of claim 17, wherein the operations further comprise:
collecting, using a spoilage detection machine, perishable good parameters; and
transmitting the perishable good parameters to the storage device.

19. The computer program of claim 17, wherein:
the spoilage determination module determines the spoilage risk using image recognition.

20. The computer program of claim 17, wherein the operations further comprise:
transmitting, using the meshing module, output parameters to a user device.

21. (canceled)

22. (canceled)

23. (canceled)

24. (canceled)
